(19) United States
(12) Patent Application Publication
(10) Pub. No.: US 2008/0037240 A1
(43) Pub. Date: Feb. 14, 2008

(54) LED work light with diffuse lighting and positional lighting portions

(76) Inventor: Anthony Scott Fisher, Denver, PA (US)

Correspondence Address: Galasso & Associates, LP, P.O. Box 26503, Austin, TX, 78755-0503, US

(21) Appl. No.: 11/502,089

(22) Filed: Aug. 10, 2006

(51) Int. Cl. F21V 21/08

(52) U.S. Cl. 362/103

(57) ABSTRACT

A portable work lights provides portable and positionable illumination to work areas requiring further illumination. The work light has a bifurcated illuminating housing with portions thereof adapted to pivot relative to other illuminating portions. The work light utilizes a widely dispersed and diffused set of light sources comprising a comparatively large number of white high flux light emitting diode devices spread over a face of the work light, the diffused lighting reducing shadows and glare. The work light is equipped with a collapsible hook type hanger and power cord retractably wound to a cable reel.

### FIELD OF THE DISCLOSURE

The disclosures made herein relate generally work lights used to illuminate work areas and items being worked on and, more particularly, to rugged light-weight work lights providing illumination from a diffused set of semiconductor white light emitting diode devices, the work light having a three position adjustable swivel head.

### BACKGROUND

Task work lights are well known. Such work light are often employed to illuminate dark or recessed work areas when servicing automobiles, working on plumbing under sinks, or working inside confined or darkened spaces for example. Such work lights typically have a handle or other means of holding the light, a power cord, and a lamp to provide illumination. Typically lamps include incandescent lamps which have a thin filament which is strongly electrically heated within a thin glass bulb having an inert gas or vacuum. Other varieties of work lights include those using fluorescent lamps constructed of a closed thin glass tube having ignition filaments on opposing ends and a mercury droplet therein, the mercury vaporizing to a gas plasma which serves to conduct electricity through the fluorescent tube and illuminate via ultraviolet light a phosphor coating on the inside of the glass tube, the phosphor coating producing the visible light used to illuminate the task or work area.

The use of incandescent lamps in work lights has one or more drawbacks. A technician working on an automobile for example, usually positions the work light near to the area being worked on to achieve the strongest lighting. Incandescent 120 volt lamps as often used in such work lights generate a significant amount of infrared radiation and heat. Such work lights are often hot to the touch and can be a source of skin burns to a user. Also, working directing in front of such a light can be uncomfortable due to the generated heat. Incandescent lamps also tend to be fragile and not well suited to being manipulated, moved and dropped, this is particularly a drawback for a work light application. The filaments in incandescent bulbs are thin and fragile, break easily and therefore don't hold up well to bumps and jars that a work light regularly experiences. Also the thin clear glass envelope of the incandescent bulb is easily shattered by a sudden knock, or by a cold object such as a water drop falling onto the glass envelope of the incandescent lamp.

The use of fluorescent lamps in work lights have one or drawbacks. Fluorescent lamps have thin glass envelopes similar to incandescent lamps and are susceptible to breakage of the glass envelope if jarred or dropped. Work light are often jarred against objects, fall from hangers or are dropped and so a fragile lamp is a serious drawback. Having work lights that are fragile, break easily and leave shards of broken glass lying about to cause injury is not a good thing, and particularly problematic in a confined work area. Fluorescent lamps also contain environmentally troublesome materials such as mercury and phosphors.

Work lights are often equipped with a clear lens to provide some protection to the fragile glass lamp of the work light. The lens, however, are problematic in themselves. Glass lens are fragile and prone to breakage, and therefore are not often used in work lights. Clear plastic lens, while being relatively shatterproof, are easily scratched and discolored by the presence of oil and solvents in the work area, for example around automotive work.

Another limitation of conventional work lamps is that the use or of incandescent or fluorescent lamps, which generally have a relative large form factor when compared to the dimensions of the work light, results in a work light that do not have illuminating portions which can be adjusted or pivoted relative to each other. Having a work light that has an extended light bar having multiple light generating sources that can pivot and swivel to conform to space limitation, as well as to provide more flexibility in ways to hang or support the light on equipment being work on is an advantage, and an advantage not generally achievable with conventional work lights.

Yet another limitation of conventional work lights is that incandescent or fluorescent lamps are well known to have a shorter operating life expectancy than solid state semiconductor lamps such as light emitting diodes.

Yet another limitation of conventional work lights is that work lights utilizing one or two illuminating lamps tend to cast shadows on the work area as well as to be conducive to distracting and vision limiting reflected glare off surfaces which have a surface normal which is inclined at a mid angular position between the work lamp and the eye of the observer.

Therefore, a work light which is adjustable, having illuminating portions which are adapted to pivot and swivel relative to each other to confirm to space limitations as well as to provide more flexibility in ways to hang or support the light on equipment, a work light that is rugged by design and avoids the use of lamps that are fragile and easily broken, a work light that operates cool to the touch rather than operating at elevated temperatures such as conventional incandescent work lights, a work light that avoids the use of lamps that are easily shattered and spread sharp glass shards into the work area, a work light using illuminating lamps having a comparatively long life, a work light that reduces if not eliminates the occurrence of shadows and reflected glare by the use of a generous number of light sources distributed over the body of the work light, a work light that avoids the use of a plastic lens that can be easily discolored or scratched, a work light made of durable materials that is easily cleaned of oils, grease and other accumulated debris, such a work light would be useful and novel.

### SUMMARY OF THE DISCLOSURE

Accordingly, embodiments of the inventive disclosures made herein comprise portable work lights used to provide usable level of illumination to work areas. Embodiments of the inventive disclosure herein comprise a work light having a bifurcated illuminated housing wherein portions thereof are adapted to pivot relative to other portions, and where the work light utilizes a widely diffused light source comprising a comparatively large number of white light emitting diode devices.

In a first embodiment of the inventive disclosures made herein, the work light comprises a housing having two or more illumination generating portions, each portion having multiple illuminators distributed thereon. Adjacent housing portions are mechanically interconnected and enabled to lockably pivot relative to each other. A plurality of white light emitting diode illuminators distributed over and secured to the housing so as to provide a diffuse light source. A collapsible hook shaped hanger extends outwards from the top surface of the upper portion of the housing. The hanger provides a means of hanging the work lamp from any available supportive element in the work area. The hanger is configured to swivel relative to the housing and to be collapsible or slidable into the housing. A magnet secured to an upper portion of the housing. The work light has a flexible insulated electrical supply cable having a first end secured to the housing and an opposing second end equipped with an electrical plug. The work light includes a cable storage reel for retractably storing portions of the length of said electrical supply cable.

In a second embodiment of the inventive disclosures made herein, the work light having diffuse lighting and positional portions comprises an elongated first half-cylindrical housing having a plurality of holes distributed over cylindrical face of the housing. A plurality of light emitting diodes is disposed in the holes and mounted to the first housing. The light emitting diodes generating a directed beam of light substantially normal to the half-cylindrical face, the light emitting diodes emitting a white light. An elongated second half-cylindrical housing is pivotally connected to the first half-cylindrical housing, the second half-cylindrical housing having a plurality of holes distributed over cylindrical face of the housing. A generous number or plurality of light emitting diodes are disposed, one is each hole, in second half housing. The light emitting diodes generate a directed beam of light substantially normal to the cylindrical face of the second half housing, the light emitting diodes emitting a white light. A collapsible, (by which we mean collapsible into and extensible outwards from the housing) hook shaped hanger is provided extending outwards from a top surface of the second half-cylindrical housing, the hanger having a portion collapsible into the second housing. The hook shaped hanger is for supportively hanging the work light while in use. A three position locking hinge member pivotally connects a top portion of the first housing to a bottom portion of the second housing. The hinge member enables the first and second housing to lockably pivot at positions of the second longitudinal axis at 0, 45 and 90 degrees relative to the first longitudinal axis. A release button is provided on the housing for releasing the lock of the locking hinge member to enable to second housing to pivot relative to the first housing. The work light further includes a magnet secured to an upper portion of the cylindrical face of the second housing. Power is provided to the work light through a flexible insulated electrical supply cable having a first end secured to the first housing and an opposing second end having an electrical plug. The power chord preferably has an oil resistant sheath.

In another embodiment of the inventive disclosures made herein, the second embodiment is modified such that the number of light emitting diodes in the upper and lower housing totals to at least ninety light emitting diodes, providing a dispersed and diffused illumination.

In another embodiment of the inventive disclosures made herein, the work light is equipped with a cable storage reel for retractably storing portions of the length of the electrical supply cable. The cable is equipped with an oil resistant insulation and measures 30 feet in length.

In another embodiment of the inventive disclosures made herein, the work light is power source is a 120 volt alternating current supply.

In another embodiment of the inventive disclosures made herein, the work light is power source is a 12 volt automotive battery, the power cord is equipped with an automotive electrical accessory plug configured to be received into and electrically mate with an automotive accessory power socket.

In another embodiment of the inventive disclosures made herein, the work light is equipped with a rechargeable battery, and provided with a 120 volt charging transformer configured to recharge the battery of the work light.

In one or more embodiments of the inventive disclosures made herein, the work light housing comprises a formed thermoplastic material consisting of polyethylene, polypropylene or other similar thermoplastic materials.

In at least one embodiment of the inventive disclosures made herein, the work light housing has a length of 24 inches and a width across the illuminated half-cylindrical face of 1½ to 2 inches. The half-cylindrical housings have a 5 inch diameter and are 1½ inches deep.

It is an objective of the inventive disclosure made herein to provide a work light which is adjustable, having illuminating portions which are adapted to pivot and swivel relative to each other to confirm to space limitations as well as to provide more flexibility in ways to hang or support the light on equipment.

It is an objective of the inventive disclosure made herein to provide a work light that is rugged by design and avoids the use of lamps that are fragile and easily broken.

It is an objective of the inventive disclosure made herein to provide a work light that operated cool to the touch rather than operating at elevated temperatures such as conventional incandescent work lamps.

It is an objective of the inventive disclosure made herein to provide a work light that avoids the use of lamps that are easily shattered and spread sharp glass shards into the work area.

It is an objective of the inventive disclosure made herein to provide a work light using illuminating lamps having a comparatively long life.

It is an objective of the inventive disclosure made herein to provide a work light that reduces if not eliminates the occurrence of shadows and reflected glare by the use of a generous number of light sources distributed over the body of the work light.

It is an objective of the inventive disclosure made herein to provide a work light that avoids the use of a plastic lens as such lenses can be easily discolored and scratched.

It is an objective of the inventive disclosure made herein to provide a work light that is made of durable materials that are easily cleaned of oils, grease and other accumulated debris.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one embodiment of a work light in accordance with the inventive disclosures herein.

FIG. 2 depicts a front view of one embodiment of a work light in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

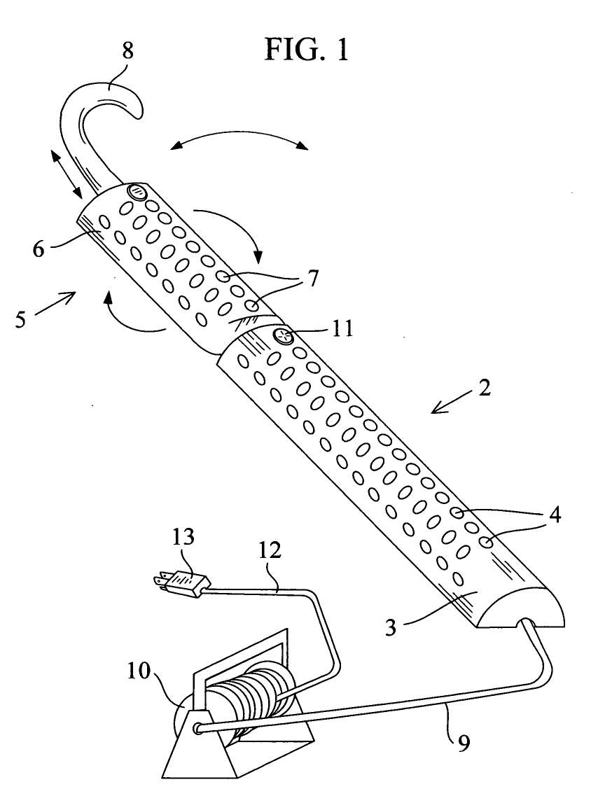

FIG. 1 depicts a perspective view of one embodiment of a work light in accordance with the inventive disclosures herein. The work light comprises an elongated first half-cylindrical housing 2 having a plurality of holes distributed over cylindrical face 3 of the housing. A plurality of ultra bright white light emitting diodes 4 are disposed in the holes and mounted to or within the housing. An elongated second half-cylindrical housing 5 similarly has a plurality of holes distributed over cylindrical face 6 of the housing. A plurality of ultra bright white light emitting diodes 7 are disposed in the holes in second half housing and mounted to or within the second half housing. The work light has a collapsible hook shaped hanger 8 extending outwards from a top surface of the second half-cylindrical housing 5. The hanger 8 has a portion slidable or collapsible into the second housing 5. The hook is adapted for supportively hanging the work light while in use to illuminate a task or work piece. A three position locking hinge member (not shown) pivotally connects the top portion of the first or lower housing to a bottom portion of the second or upper housing. The hinge member enabling the first and second housing to lockably pivot at fixed positions of 0, 45 and 90 degrees in relation to each other. The upper portion of the first or lower housing includes a release button 11 for releasing the lock of the locking hinge member to enable to second housing to pivot relative to the first housing. A magnet is secured to an upper portion of the half-cylindrical face of the second housing. A first section of flexible insulated electrical supply cable 9 having oil resistant jacket has one end secured to the lower housing 3 and electrically connected to the circuitry of the housing providing power to illuminate the light emitting diodes 4,7. The opposing end of the flexible cable 9 is secured to the cable retracting cable reel means 10. A second section of flexible insulated electrical supply cable 12 having oil resistant jacket has one end retractably receiving onto the cable reel means 10 and electrically connected to the first section of flexible cable. The opposing end of the second section of cable has an electrical plug 13 secured and electrically connected to the cable.

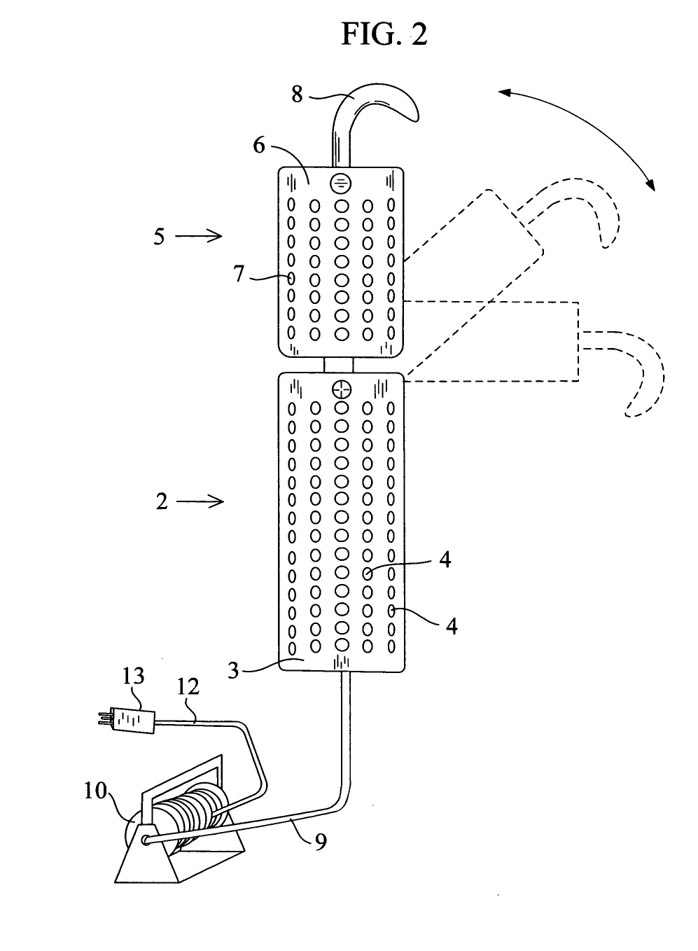

FIG. 2 depicts a front view of one embodiment of a work light in accordance with the inventive disclosures herein. A three position locking hinge member (not shown) pivotally connects the top portion of the first or lower housing to a bottom portion of the second or upper housing. The hinge member enabling the first and second housing to lockably pivot at fixed positions of 0, 45 and 90 degrees in relation to each other, as illustrated.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, electrical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A work light comprising:
a housing having two or more illumination generating portions, the portions mechanically interconnected and adapted to lockably pivot relative to adjacent portions;
a plurality of white light emitting diode illuminators distributed over and secured to the housing so as to provide a diffuse light source;
a collapsible hook shaped hanger extending outwards from a top surface of an upper portion of the housing, the hanger having a portion collapsible into the upper housing;
a magnet secured to an upper portion of the housing;
a flexible insulated electrical supply cable having a first end secured to the housing, and an opposing second end having an electrical plug means, the electrical supply cable conducting electrical energy from a power source to the work light to energize the work light.

2. The work light of claim 1, wherein the plurality of white light illuminators is at least ninety illuminators.

3. The work light of claim 2, wherein the electrical supply cable comprises:
a first section of flexible insulated electrical supply cable having a first end secured to the housing, and an opposing second end secured to a cable reel means; and
a second section of flexible insulated electrical supply cable having a first end retractably received onto the cable reel means, the first and second cables electrically connected at the cable reel means, the cable reel means for retractably windably storing the second section of cable.

4. The work light of claim 3, wherein the two or more portions consist of two portions.

5. A work light having diffuse lighting and positional portions, comprising:
an elongated first half-cylindrical housing having a plurality of holes distributed over cylindrical face of the housing, the housing having a first longitudinal axis;
a plurality of ultra bright light emitting diodes disposed in said holes and mounted to said housing, the light emitting diodes generating a directed beam of light substantially normal to the cylindrical face, the light emitting diodes emitting a white light;
an elongated second half-cylindrical housing having a plurality of holes distributed over cylindrical face of the housing, the housing having a second longitudinal axis;
a plurality of ultra bright light emitting diodes disposed in said holes in second half housing and mounted to said second half housing, the light emitting diodes generating a directed beam of light substantially normal to the cylindrical face of the second half housing, the light emitting diodes emitting a white light;
a collapsible hook shaped hanger extending outwards from a top surface of the second half-cylindrical housing, the hanger having a portion collapsible into the second housing, the hanger extending substantially parallel to the second longitudinal axis, the hook for supportively hanging the work light while in use;
a three position locking hinge member pivotally connecting a top portion of the first housing to a bottom portion of the second housing, the hinge member enabling the first and second housing to lockably pivot at positions of the second longitudinal axis at 0, 45 and 90 degrees relative to the first longitudinal axis;
a release button for releasing the lock of the locking hinge member to enable to second housing to pivot relative to the first housing;
a magnet secured to an upper portion of the cylindrical face of the second housing; and
a flexible insulated electrical supply cable having a first end secured to the first housing, and an opposing second end having an electrical plug means, the electrical supply cable conducting electrical energy from a power source to the LED work light to energize the work light.

6. The work light of claim 5 wherein the plurality of light emitting diodes in the upper and lower housing totals to at least ninety light emitting diodes.

7. The work light of claim 6, wherein the cable has an oil resistant jacket, the work light further comprising a cable storage reel for retractably storing portions of the length of said electrical supply cable.

8. The work light of claim 7, wherein the electrical supply cable comprises:
a first section of flexible insulated electrical supply cable having a first end secured to the housing, and an opposing second end secured to a cable reel means;
a second section of flexible insulated electrical supply cable having a first end retractably received onto the cable reel means, the first and second cables electrically connected at the cable means, the cable real means for retractably windably storing the second section of cable.

9. The work light of claim 8, wherein the power source is a 120 volt alternating current supply, and the electrical plug means is a 120 volt electrical plug configured to electrically mate with a 120 volt electrical receptacle.

10. The work light of claim 8, wherein the power source is a 12 volt automotive battery, and the electrical plug means is and automotive electrical accessory plug configured to be received into and electrically mate with an automotive accessory power socket.

11. The work light of claim 7, wherein the power source is a rechargeable battery internal to the first housing and the electrical plug means is a charging power supply module having a 120 volt electrical plug secured thereto, the power supply module configured to charge the battery of the work light.

12. The work light of claim 8, wherein the work light housing has a length of 24 inches, the housing has a width across the illuminated half-cylindrical face of 1½ to 2 inches, the half-cylindrical housings have a 5 inch diameter and are 1½ inches deep.
